(19) United States
(12) Patent Application Publication
(10) Pub. No.: US 2023/0333568 A1
(43) Pub. Date: Oct. 19, 2023

(54) TRANSPORT VEHICLE SYSTEM, TRANSPORT VEHICLE, AND CONTROL METHOD

(71) Applicant: MURATA MACHINERY, LTD., Kyoto-shi, Kyoto (JP)

(72) Inventor: Masaaki MATSUMOTO, Inuyama-shi (JP)

(21) Appl. No.: 17/608,535

(22) PCT Filed: May 12, 2020
(86) PCT No.: PCT/JP2020/018937

§ 371 Date: Nov. 3, 2021

(30) Foreign Application Priority Data
May 17, 2019 (JP) 2019-093501

(51) Int. Cl. G05D 1/02; G01C 21/28

(52) U.S. Cl. CPC G05D 1/0274; G01C 21/28

(57) ABSTRACT

In a transport vehicle system including transport vehicles and a storage, each of the transport vehicles has a laser range sensor, an onboard controller, and a communicator. The storage stores an environment map. The onboard controller includes an own position estimator and a first periphery information generator. The own position estimator estimates an own position of the own transport vehicle based on periphery information of the own transport vehicle, currently recognized position information of the own transport vehicle, and the environment map. When supplementary information is obtained via the communicator of the own transport vehicle, the first periphery information generator adds the supplementary information to sensor information of the own transport vehicle to generate the periphery information of the own transport vehicle.

### BACKGROUND OF THE INVENTION

### 1. Field of the Invention

The present invention relates to a transport vehicle system. In particular, the present invention relates to a transport vehicle system including a plurality of transport vehicles traveling in a movement area while estimating positions of the transport vehicles in the movement area, and to a transport vehicle included in the transport vehicle system, and to a method for controlling a transport vehicle.

### 2. Description of the Related Art

Conventionally, there is known a moving body traveling autonomously in a movement area while estimating its position in the movement area. For instance, there is known a moving body that utilizes a simultaneous localization and mapping (SLAM) technique in which estimation of position and generation of an environment map are performed in real time (e.g., see JP-A-2014-186694).

This moving body utilizes the SLAM to estimate positions by performing matching between the environment map and a local map obtained as a result of distance measurement using a laser range finder (LRF), a camera, or the like.

### SUMMARY OF THE INVENTION

It is being studied in a mobile environment to allow a plurality of moving bodies using the SLAM technique as an own position estimation method to autonomously travel. When allowing a plurality of moving bodies to travel, for example, in front of one moving body, another moving body or an obstacle may exist. In this case, the another moving body or the obstacle may block a field of view of the LRF or the camera, so that the one moving body behind the another moving body or the obstacle cannot obtain a sufficient local map.

As a result, in the one moving body, own position estimation accuracy may be deteriorated, or a wrong own position may be estimated.

In addition, when a plurality of moving bodies are allowed to travel autonomously and if a specific moving body cannot obtain a sufficient local map, it may be possible to estimate an own position of the specific moving body based on an estimated position of another moving body that can obtain a sufficient local map and a relative distance between the another moving body and the specific moving body. In this case, it is necessary to change the own position estimation method in accordance with a state of the local map, and hence the process of own position estimation becomes complicated.

Preferred embodiments of the present invention provide transport vehicle systems each including a plurality of transport vehicles using a SLAM technique as an own position estimation method, to reduce an influence of existence of another transport vehicle or an obstacle so as to accurately estimate an own position without changing the own position estimation method.

A plurality of aspects of example preferred embodiments of the present invention are described below. These aspects can be arbitrarily combined as necessary.

A transport vehicle system according to one aspect of an example preferred embodiment of the present invention includes a plurality of transport vehicles, and a map data storage. Each of the plurality of transport vehicles includes a distance measurement sensor, an onboard controller, and a communicator. The map data storage is configured to store map data that stores a peripheral object existing in a movement area.

The onboard controller of the transport vehicle is configured or programmed to includes an estimator and a first periphery information generator. The estimator is configured or programmed to estimate an own position of a transport vehicle based on first periphery information, currently recognized position information of the own transport vehicle (a main body of the transport vehicle equipped with the onboard controller), and the map data. The first periphery information is periphery information of the own transport vehicle including first sensor information obtained by the distance measurement sensor of the own transport vehicle.

If supplementary information is obtained via the communicator of the own transport vehicle, the first periphery information generator adds the supplementary information to the first sensor information to generate the first periphery information. The supplementary information includes second sensor information obtained by the distance measurement sensor of another transport vehicle.

In the transport vehicle system described above, in the own transport vehicle, if the supplementary information is obtained from another transport vehicle via the communicator, the first periphery information generator adds the supplementary information to the first sensor information obtained by the distance measurement sensor to generate the first periphery information that is used to estimate an own position of the own transport vehicle.

In this way, the supplementary information stored in another transport vehicle is added to the sensor information obtained by the own transport vehicle to generate the first periphery information. Since the first periphery information has more information than the first sensor information, the own transport vehicle can estimate the own position more accurately.

In addition, as the supplementary information stored in another transport vehicle is added to the first sensor information of the own transport vehicle, even if an unexpected obstacle including another transport vehicle exists in a periphery of the own transport vehicle, the own transport vehicle can reduce an influence of an existence of the obstacle, so that the own position estimation can be accurately performed. Even if sufficient first sensor information cannot be obtained due to the existence of the unexpected obstacle, the own transport vehicle can generate the first periphery information including more information by adding the supplementary information to the first sensor information of the own transport vehicle.

The first periphery information generator may add the supplementary information to the first sensor information based on the position information of the own transport vehicle and the position information of the another transport vehicle. In this way, more accurate first periphery information can be generated based on a positional relationship between the own transport vehicle and the another transport vehicle.

The first periphery information generator may offset the supplementary information by a difference between the position information of the own transport vehicle and the position information of the another transport vehicle, and add the supplementary information to the first sensor information. In this way, more accurate first periphery information can be generated.

The plurality of transport vehicles may directly communicate with each other. In this case, the position information of the another transport vehicle can be obtained together with the supplementary information from the another transport vehicle via the communicator. In this way, since the position information of the another transport vehicle can be obtained without using other device such as a host controller, a load on the other device (host controller) can be reduced. In addition, as the transport vehicles directly communicate with each other to obtain the position information of the another transport vehicle, communication loss in obtaining the position information can be reduced.

The position information of the another transport vehicle may also be recognized based on information obtained by the distance measurement sensor of the own transport vehicle. In this way, it is not necessary to receive the position information of the another transport vehicle from the another transport vehicle.

The first periphery information generator may obtain the supplementary information from the another transport vehicle specified based on specifying information. The specifying information is information specifying the transport vehicle. In other words, the specifying information is information that can be used to specify the another transport vehicle, such as information showing characteristics of the transport vehicle, information identifying the transport vehicle, conditions specifying the transport vehicle, or the like.

After specifying the another transport vehicle based on the specifying information, the first periphery information generator obtains the supplementary information from the another transport vehicle, and hence it can add the supplementary information to the first sensor information of the own transport vehicle before the own transport vehicle becomes abnormal (e.g., abnormal stop) due to insufficient first sensor information. As a result, it is possible to reduce a possibility of an occurrence of an abnormality (e.g., an abnormal stop) in the own transport vehicle.

The transport vehicle may further include a camera to photograph a front in a travel direction. In this case, the specifying information is appearance information of the another transport vehicle photographed by the camera. In this way, the another transport vehicle can be specified more accurately based on appearance of the another transport vehicle.

The transport vehicle system described above may further include a host controller. The host controller allocates transport commands to the plurality of transport vehicles. In this case, the specifying information is information about the another transport vehicle recognized by the host controller as existing close to a transport route of the own transport vehicle based on the transport command. In this way, it is possible to obtain the supplementary information from the another transport vehicle specified by the host controller.

The specifying information may be information about the another transport vehicle in a range communicable via the communicator. In this way, it is possible to obtain the supplementary information from the another transport vehicle within a limited range, and communication load of the communicator can be reduced.

The first periphery information generator may obtain the supplementary information from all of the other transport vehicles. In this way, as the supplementary information can be obtained from all of the other transport vehicles, more supplementary information can be added to the first sensor information of the own transport vehicle, and more accurate position estimation can be performed.

If the supplementary information cannot be obtained via the communicator of the own transport vehicle, the first periphery information generator may set the first sensor information to the first periphery information.

In this way, even if the own transport vehicle cannot obtain the supplementary information stored in the another transport vehicle, it can perform position estimation by comparing the first periphery information with the map data. In other words, the own transport vehicle can use the same own position estimation method regardless whether or not the supplementary information is obtained.

A transport vehicle according to another aspect of an example preferred embodiment of the present invention is a transport vehicle of a transport vehicle system including a plurality of transport vehicles traveling in a movement area. The transport vehicle includes a distance measurement sensor, a communicator, an estimator, and a first periphery information generator.

The estimator is configured or programmed to estimate the own position based on first periphery information including first sensor information obtained by the distance measurement sensor, currently recognized position information, and map data storing a peripheral object existing in the movement area.

If supplementary information including second sensor information obtained by the distance measurement sensor of another transport vehicle is obtained via the communicator, the first periphery information generator is configured or programmed to add the supplementary information to the first sensor information to generate the first periphery information.

In the above-mentioned transport vehicle (referred to as an own transport vehicle), if the supplementary information is obtained from another transport vehicle via the communicator, the first periphery information generator adds the supplementary information to the first sensor information obtained by the distance measurement sensor of the own transport vehicle, to generate the first periphery information that is used to estimate an own position of the own transport vehicle. In this way, the supplementary information stored in the another transport vehicle is added to the sensor information obtained by the own transport vehicle to generate the first periphery information. As the first periphery information has more information than the first sensor information, the own transport vehicle can estimate the own position more accurately.

In addition, as the supplementary information stored in another transport vehicle is added to the first sensor information of the own transport vehicle, even if an unexpected obstacle including another transport vehicle exists in a periphery of the own transport vehicle, the own transport vehicle can reduce an influence of an existence of the obstacle, and the own position estimation can be accurately performed. Even if sufficient first sensor information cannot be obtained due to the existence of the unexpected obstacle, the own transport vehicle can generate the first periphery information including more information by adding the supplementary information to the first sensor information of the own transport vehicle.

A control method according to still another aspect of an example preferred embodiment of the present invention is a method of controlling an own transport vehicle in a transport vehicle system including a plurality of transport vehicles equipped with a distance measurement sensor and a communicator and configured to travel in a movement area, and a map data storage to store map data storing a peripheral object existing in the movement area. The control method includes obtaining first sensor information by the distance measurement sensor of the own transport vehicle, determining whether or not supplementary information including second sensor information obtained by the distance measurement sensor of another transport vehicle can be obtained via the communicator of the own transport vehicle, generating first periphery information by adding the supplementary information to the first sensor information, if the supplementary information including the second sensor information obtained by the distance measurement sensor of another transport vehicle is obtained via the communicator, and estimating own position of the own transport vehicle based on the first periphery information, currently recognized position information of the own transport vehicle, and map data.

In the above-mentioned method of controlling own transport vehicle, if supplementary information is obtained from another transport vehicle via the communicator of the own transport vehicle, a first periphery information generator of the own transport vehicle adds the supplementary information to the first sensor information obtained by the distance measurement sensor of the own transport vehicle, to generate the first periphery information that is used to estimate an own position of the own transport vehicle. In this way, the supplementary information stored in the another transport vehicle is added to the sensor information obtained by the own transport vehicle, and hence the first periphery information is generated. As the first periphery information has more information than the first sensor information, the own transport vehicle can estimate the own position more accurately.

In addition, as the supplementary information stored in the another transport vehicle is added to the first sensor information of the own transport vehicle, even if an unexpected obstacle including another transport vehicle exists in a periphery of the own transport vehicle, the own transport vehicle can reduce an influence of an existence of the obstacle, and the own position estimation can be accurately performed. Even if sufficient first sensor information cannot be obtained due to existence of the unexpected obstacle, the own transport vehicle can generate the first periphery information including more information by adding the supplementary information to the first sensor information of the own transport vehicle.

In a transport vehicle system including a plurality of transport vehicles using a SLAM technique as an own position estimation method, it is possible to reduce an influence of an existence of another transport vehicle or an obstacle to accurately estimate the own position without changing the own position estimation method.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic plan view of a transport vehicle system as a first preferred embodiment of the present invention.

FIG. 2 is a schematic structural diagram of a transport vehicle.

FIG. 3 is a block diagram illustrating a structure of a controller.

FIG. 4 is a flowchart illustrating a basic operation of the transport vehicle when traveling autonomously.

FIG. 5 is a flowchart illustrating an operation of generating periphery information.

FIG. 6 is a flowchart illustrating an own position estimation operation.

FIG. 7 is a diagram illustrating an example of a case where another transport vehicle exists in front of the own transport vehicle.

FIG. 8A is a diagram illustrating an example of sensor information obtained by the own transport vehicle.

FIG. 8B is a diagram illustrating an example of periphery information obtained by another transport vehicle.

FIG. 9 is a diagram illustrating an example of a case where the periphery information of another transport vehicle is added as it is.

FIG. 10 is a diagram illustrating an example of a case where the periphery information of another transport vehicle is offset and then is added.

FIG. 11 is a diagram illustrating another example of a case where another transport vehicle exists in front of the own transport vehicle.

FIG. 12 is a diagram illustrating another example of a case where the periphery information of another transport vehicle is offset and then is added.

### DETAILED DESCRIPTION OF THE PREFERRED EMBODIMENTS

### First Preferred Embodiment

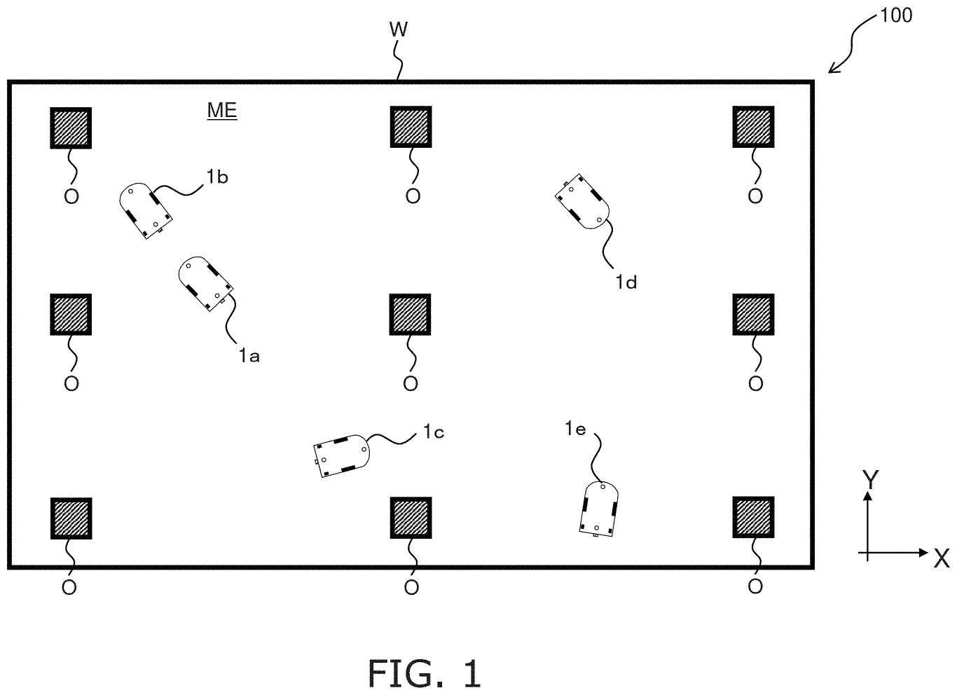

Hereinafter, with reference to FIG. 1, a structure of a transport vehicle system 100 of a first preferred embodiment of the present invention is described. FIG. 1 is a schematic plan view of the transport vehicle system as the first preferred embodiment of the present invention. The transport vehicle system 100 includes a plurality of transport vehicles 1a, 1b, 1c, 1d, and 1e. The plurality of transport vehicles 1a to 1e are transport robots that travel in a movement area ME (e.g., in a factory). The plurality of transport vehicles 1a to 1e have the same shape, or shapes of all transport vehicles are known.

It should be noted that five transport vehicles are shown in FIG. 1, but the number of them is not limited.

It should be noted that in the following description, when generally describing a transport vehicle 1, it is referred to as the “transport vehicle 1”.

In addition, in the movement area ME, marks (not shown) that can be detected by a laser range sensor 13 are arranged at predetermined spaces. In this way, the transport vehicles 1a to 1e can perform own position estimation at any position in the movement area ME.

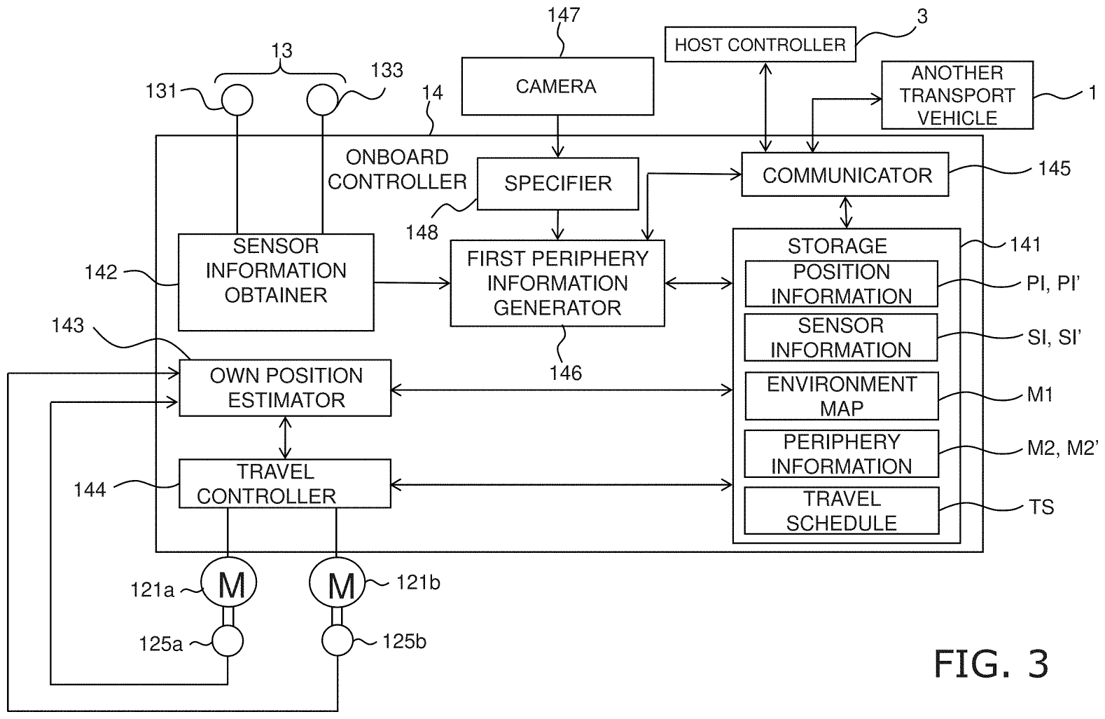

The transport vehicle system 100 includes a host controller 3 (FIG. 3). The host controller 3 is a general computer in the same manner as an onboard controller 14 described later.

The host controller 3 can communicate with the plurality of transport vehicles 1a to 1e. The host controller 3 controls the transport vehicle system 100. Specifically, the host controller 3 allocates transport commands to the transport vehicles 1a to 1e, and sends the allocated transport commands to the corresponding transport vehicles 1a to 1e.

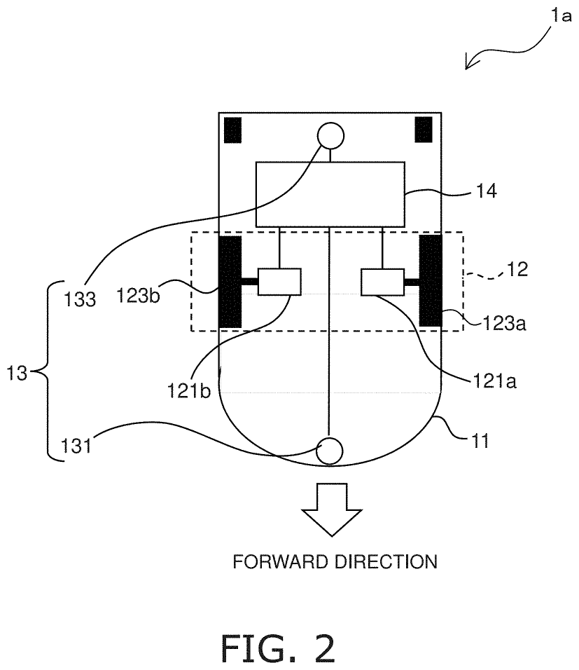

Next, with reference to FIG. 2, a structure of the transport vehicle 1 is described. FIG. 2 is a schematic structural diagram of the transport vehicle.

The transport vehicle 1 includes a main body 11. The main body 11 is a casing of the transport vehicle 1. In this preferred embodiment, an “own position” described later is defined as a center position (coordinates) of the main body 11 on an environment map indicating the movement area ME.

The transport vehicle 1 includes a mover 12. The mover 12 is, for example, a differential two wheel type traveler or conveyor configured to move the main body 11.

Specifically, the mover 12 includes a pair of motors 121a and 121b. The pair of motors 121a and 121b are electric motors such as servo motors or brushless motors mounted on a bottom part of the main body 11.

The mover 12 includes a pair of drive wheels 123a and 123b. The pair of drive wheels 123a and 123b are connected to the pair of motors 121a and 121b, respectively.

The transport vehicle 1 includes a laser range sensor 13 (an example of a distance measurement sensor). The laser range sensor 13 radially emits a laser beam pulse-oscillated by a laser oscillator, for example, toward a material placement portion O or a wall W in the movement area ME, and receives reflection light reflected with a laser receiver, to obtain information thereabout. The laser range sensor 13 is a laser range finder (LRF), for example.

The laser range sensor 13 includes a front laser range sensor 131 disposed at a front portion of the main body 11 and a rear laser range sensor 133 disposed at a rear portion of the main body 11.

The front laser range sensor 131 is disposed at the front portion of the main body 11. The front laser range sensor 131 emits the laser beam radially in the left and right direction, so as to obtain information about the material placement portion O, the wall W, and another transport vehicle 1 existing in front of the main body 11 with respect to the front laser range sensor 131 as the center. An object detection range of the front laser range sensor 131 is, for example, a circle having a radius of approximately 20 meters in front of the main body 11.

The rear laser range sensor 133 is disposed at the rear portion of the main body 11. The rear laser range sensor 133 emits the laser beam radially in the left and right direction, to obtain information about the material placement portion O, wall W, and another transport vehicle 1 existing behind the main body 11 with respect to the rear laser range sensor 133 as the center. An object detection range of the rear laser range sensor 133 is, for example, a circle having a radius of approximately 20 meters behind the main body 11.

It should be noted that the detectable distance of the laser range sensor is not limited to the value described above, but can be appropriately changed depending on the application or the like of the transport vehicle system 100.

The transport vehicle 1 includes a material holder and/or a material transfer device (not shown). In this way, the transport vehicle 1 can transport a material and transfer the material to or from another device.

The transport vehicle 1 includes the onboard controller 14. Hereinafter, with reference to FIG. 3, a structure of the onboard controller 14 is described. FIG. 3 is a block diagram illustrating a structure of the controller.

The onboard controller 14 is a computer system including a processor (such as a CPU), a storage device (such as a ROM, a RAM, an HDD, and an SSD), and various interfaces (such as an A/D converter, a D/A converter, and a communication interface). The onboard controller 14 executes a program stored in the storage (corresponding to a part or a whole of storage areas of the storage device) to perform various control operations.

The onboard controller 14 may include a single processor or a plurality of independent processors for individual controls.

A portion or an entirety of functions of individual elements of the onboard controller 14 may be realized as a program that the computer system of the controller can execute. Other than that, a portion or an entirety of functions of individual elements of the controller can be performed by a custom IC.

Although not illustrated, the onboard controller 14 is connected to sensors and switches to detect states of individual devices, and an information input device.

The onboard controller 14 includes a storage 141. The storage 141 is a portion of storage areas of the storage device of the computer system of the onboard controller 14. The storage 141 stores various information that are used to control the transport vehicle 1.

Specifically, the storage 141 stores an environment map M1 (an example of map data). The environment map M1 is, for example, a set of coordinate value data indicating positions of the material placement portions O and/or the walls W on a coordinate plane indicating the movement area ME, and is a map indicating a portion or a whole of the movement area ME. The environment map M1 may be the entire map or a plurality of partial maps for indicating the entire movement area ME.

The storage 141 stores position information PI and periphery information M2. The position information PI is information about a position of the own transport vehicle (own position) expressed as coordinate values on an X-Y coordinate. The X-Y coordinate is a coordinate system by which the environment map M1 is defined. The position information PI indicates own position and own direction estimated by an own position estimator 143.

The periphery information M2 is information that is used to estimate the own position by the own position estimator 143.

The onboard controller 14 is configured or programmed to include a sensor information obtainer 142. The sensor information obtainer 142 generates sensor information SI based on a signal obtained from the laser range sensor 13. The sensor information obtainer 142 stores the generated sensor information SI in the storage 141.

Specifically, the sensor information SI is generated as follows.

The sensor information obtainer 142 first calculates a distance between the laser range sensor 13 and an object based on a time difference between timing when the laser range sensor 13 emits the laser beam and timing when the laser range sensor 13 receives the reflection light. In addition, it can calculate a direction of the object viewed from the main body 11 based on an angle of the light receiving surface of the laser receiver when receiving the reflection light, for example.

The onboard controller 14 includes the own position estimator 143 (an example of an estimator). The own position estimator 143 estimates an own position (coordinates of the center position) and an own direction (own direction) of the main body 11 on the environment map, while moving in the movement area ME. An operation of the own position estimator 143 will be described later.

The onboard controller 14 includes a travel controller 144. The travel controller 144 controls the motors 121a and 121b. The travel controller 144 is, for example, a motor driver that calculates control variables for the motors 121a and 121b, respectively, and outputs drive powers based on the control variables to the motors 121a and 121b, respectively. The travel controller 144 calculates the control variables of the motors 121a and 121b so that rotation speeds of the motors 121a and 121b input from encoders 125a and 125b become desired values (feedback control).

For instance, the travel controller 144 calculates the control variables of the motors 121a and 121b, respectively, based on a difference between each target point (e.g., coordinate values on the environment map) indicated in the transport command from the host controller 3 and the own position determined by the own position estimator 143, and outputs the drive powers based on the calculated control variables to these motors.

The onboard controller 14 includes a communicator 145. The communicator 145 is, for example, a wireless communication module (such as wireless LAN or Wi-Fi) that is configured or programmed to directly communicate with the host controller 3 or another transport vehicle 1 using an antenna (not shown). The communicator 145 uses, for example, a communication protocol such as user datagram protocol (UDP) or transmission control protocol/internet protocol (TCP/IP) in ad-hoc communication.

The onboard controller 14 includes a first periphery information generator 146. The first periphery information generator 146 adds supplementary information AI obtained from another transport vehicle to the sensor information SI obtained by the own transport vehicle, to generate periphery information M2 (an example of first periphery information) that is used to estimate the own position by the own position estimator 143.

The onboard controller 14 includes a camera 147. The camera 147 is disposed in the front of the main body 11 in a travel direction (forward direction in FIG. 2). The camera 147 is configured or programmed to photograph another transport vehicle 1 existing in front of the own transport vehicle, and it is a camera, for example. A specifier 148 specifies the another transport vehicle 1 existing in front of the own transport vehicle based on a photographed image obtained by the camera 147. In addition, the specifier 148 has a function of detecting an obstacle using the photographed image obtained by the camera 147.

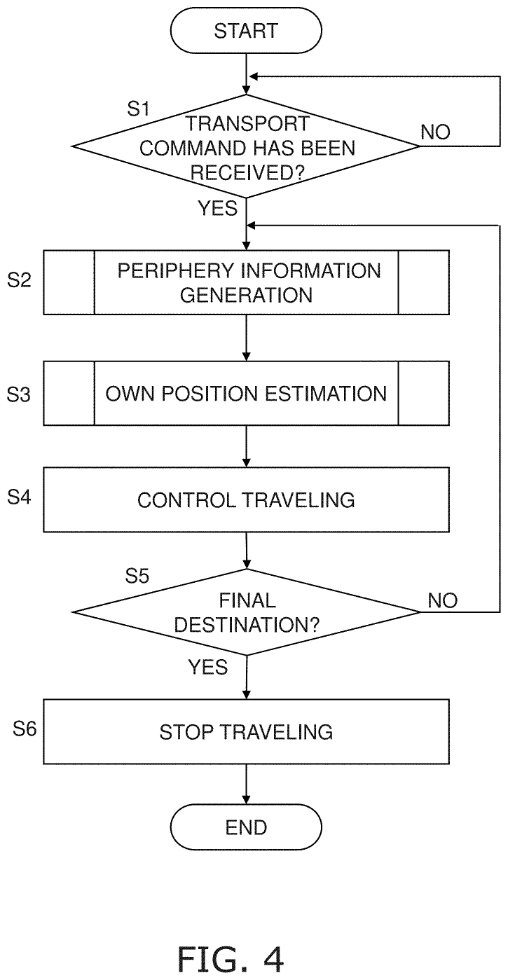

With reference to FIG. 4, a basic operation of the transport vehicle 1 when traveling autonomously is described. FIG. 4 is a flowchart illustrating a basic operation of the transport vehicle when traveling autonomously. In the following description, an operation of one of the plurality of transport vehicles 1 is described. Other transport vehicles 1 are operated in the same manner. In the following description, the reference transport vehicle 1 whose operation is described is the transport vehicle 1a illustrated in FIG. 1 and is referred to as “own transport vehicle 1a”. In addition, one of other transport vehicles 1b to 1e is referred to as “another transport vehicle”.

The control flowchart described below is merely an example, and the steps thereof can be omitted or exchanged as necessary. In addition, a plurality of steps may be simultaneously performed, or a portion or an entirety thereof may be performed in an overlapping manner.

Furthermore, each block of the control flowchart is not always a single control operation but can be replaced by a plurality of control operations expressed by a plurality of blocks.

It should be noted that operations of individual devices are a result of commands from the onboard controller 14 to the devices, and these are expressed by steps of software application.

In Step S1, the onboard controller 14 determines whether or not the transport command allocated to the own transport vehicle 1a has been received from the host controller 3. It should be noted that the transport command includes a travel schedule TS that is route information to a final destination (such as a position in front of the material placement portion O) and includes a plurality of target points. The onboard controller 14 stores the received travel schedule TS in the storage 141. However, the travel schedule TS may be generated by the onboard controller 14.

In Step S2, the periphery information M2 that is used to estimate the own position is generated. As described later in detail, when the supplementary information AI is obtained from another transport vehicle 1b via the communicator 145, the periphery information M2 is generated by adding the supplementary information AI obtained from another transport vehicle 1b to the sensor information SI obtained by the own transport vehicle 1a. In this preferred embodiment, the supplementary information AI is sensor information SI′ of another transport vehicle (that is not limited to only the another transport vehicle 1b) included in the periphery information M2 stored in the another transport vehicle 1b.

In Step S3, the own position estimator 143 estimates the own position of the own transport vehicle 1a based on the periphery information M2 generated in Step S2, signals obtained from the encoders 125a and 125b, and the environment map M1. The own position estimation method performed in Step S3 will be described later in detail.

In Step S4, the travel controller 144 calculates control variables of the motors 121a and 121b to move from the current own position to the next target point, based on a comparison between the current own position estimated in Step S2 and the next target point obtained from the travel schedule TS, and output the control variables to the motors 121a and 121b. As a result, the own transport vehicle 1a travels from the current estimated position to the next target point.

In Step S5, it is determined whether or not the final destination in the travel schedule TS has been reached. If it has been reached, the process proceeds to Step S6. If it has not been reached, the process returns to Step S2.

In Step S6, the own transport vehicle 1a stops traveling at the final destination.

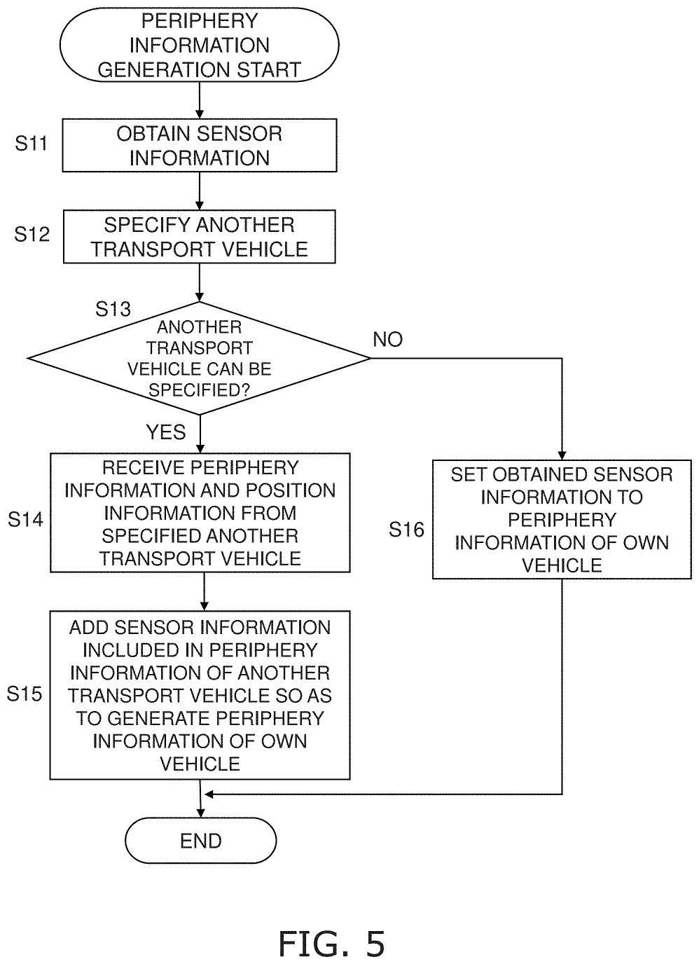

Hereinafter, with reference to FIG. 5, an operation of generating the periphery information M2 performed in Step S2 is described. FIG. 5 is a flowchart illustrating an operation of generating the periphery information M2.

In Step S11, the sensor information obtainer 142 obtains position information of an obstacle existing in a periphery of the own transport vehicle 1a as the sensor information SI.

Specifically, as for the sensor information obtainer 142, the front laser range sensor 131 and the rear laser range sensor 133 emit laser beams and further receives reflection light reflected by the obstacle.

After that, the sensor information obtainer 142 converts a detection signal outputted based on the received reflection light into the sensor information SI, which includes information about distance between the own transport vehicle 1a and the detected obstacle and information about direction of the obstacle viewed from the own transport vehicle 1a.

In Step S12, the first periphery information generator 146 specifies the another transport vehicle 1b existing close to the own transport vehicle 1a. Specifically, the another transport vehicle is specified as follows.

First, if another transport vehicle 1b is included in the image photographed by the camera 147, the specifier 148 performs image processing to extract appearance information (an example of specifying information) of the another transport vehicle 1b included in the image. The extracted appearance information is information that can specify the another transport vehicle, such as a machine number of the another transport vehicle, an identification marker attached to the another transport vehicle, or appearance of the another transport vehicle. The specifier 148 specifies the another transport vehicle 1b existing in the vicinity based on the appearance information described above. In other words, the specifying information according to this preferred embodiment is information indicating characteristics of the another transport vehicle or information for recognizing the another transport vehicle.

If the another transport vehicle 1b can be specified (“Yes” in Step S13), the periphery information generating operation proceeds to Step S14. On the other hand, if the another transport vehicle 1b cannot be specified (“No” in Step S13), the periphery information generating operation proceeds to Step S16.

The case where the another transport vehicle 1b cannot be specified based on the appearance information is, for example, a case where an image of the another transport vehicle 1b is not included in the image photographed by the camera 147, a case where appropriate appearance information cannot be obtained from the image of the another transport vehicle 1b, or the like. Hereinafter, a process when the another transport vehicle is specified (Steps S14 and S15) is described. In the Step S12 described above, it is supposed that the own transport vehicle 1a has specified another transport vehicle 1b in front thereof.

When another transport vehicle 1b is specified, the first periphery information generator 146 obtains periphery information M2′ stored in the another transport vehicle 1b via the communicator 145 in Step S14, by direct communication between the specified another transport vehicle 1b and the communicator 145. It should be noted that if the another transport vehicle 1b and the own transport vehicle 1a do not communicate directly with each other, the first periphery information generator 146 may obtain the periphery information M2′ from the another transport vehicle 1b via the host controller 3.

In this case, the first periphery information generator 146 obtains from the another transport vehicle 1b the periphery information M2′ of the another transport vehicle 1b and position information PI′ (own position and own posture of the another transport vehicle 1b), which is estimated by the another transport vehicle 1b using the periphery information M2′ of the another transport vehicle 1b. Furthermore, the first periphery information generator 146 obtains a time stamp of the periphery information M2′ stored in the another transport vehicle 1b. This time stamp indicates the time when the another transport vehicle 1b generated the periphery information M2′ and estimated its own position based thereon as the position information PI′. In other words, the position information PI′ matches time information (acquisition timing) of the periphery information M2′.

Next, in Step S15, the first periphery information generator 146 adds the supplementary information AI obtained in Step S14 to the sensor information SI obtained in Step S11, so as to generate the periphery information M2 that is used to estimate a position of the own transport vehicle 1a. In this preferred embodiment, the supplementary information AI is the sensor information SI′ included in the periphery information M2′ of the another transport vehicle 1b obtained in Step S14.

Specifically, the first periphery information generator 146 calculates actual positional relationship between the sensor information SI of the own transport vehicle 1a and the sensor information SI′ of the another transport vehicle 1b, based on the position information PI of the own transport vehicle 1a and the position information PI′ of the another transport vehicle 1b. In accordance with this positional relationship, the first periphery information generator 146 adds the sensor information SI′ of the another transport vehicle 1b as the supplementary information AI to the sensor information SI of the own transport vehicle 1a.

More specifically, the first periphery information generator 146 generates the periphery information M2 of the own transport vehicle 1a as follows. The following method of generating the periphery information M2 is an example of the method, in which the periphery information M2′ is offset by a difference between the position information of the own transport vehicle 1a and the position information PI′ of the another transport vehicle 1b, and the offset periphery information M2′ is added as the supplementary information AI to the sensor information SI obtained by the own transport vehicle 1a.

First, the first periphery information generator 146 adds the last estimated own position (position information PI) to the distance and direction change calculated from the rotation amounts of the motors 121a and 121b from the last own position estimation to the present time, so as to estimate the position and direction of the own transport vehicle 1a (position estimation by dead reckoning).

Next, the first periphery information generator 146 calculates a difference between the position and a direction of the own transport vehicle 1a estimated by dead reckoning and the position and direction indicated in the position information PI′ of the another transport vehicle 1b. Furthermore, the first periphery information generator 146 moves the periphery information M2′ in parallel by a difference between the estimated position of the own transport vehicle 1a and position of the another transport vehicle 1b. In addition, it rotates the periphery information M2′ by a difference between a current direction of the own transport vehicle 1a and a direction of the another transport vehicle 1b.

Lastly, the first periphery information generator 146 adds the sensor information SI′ included in the periphery information M2′ after the parallel movement and rotation as the supplementary information AI to the sensor information SI obtained by the own transport vehicle 1a, to generate the periphery information M2 of the own transport vehicle 1a.

In this way, if the own transport vehicle 1a can specify the another transport vehicle 1b, the first periphery information generator 146 adds the sensor information SI′ included in the periphery information M2′ of the specified another transport vehicle 1b as the supplementary information AI to the sensor information SI of the own transport vehicle 1a, to generate the periphery information M2 of the own transport vehicle 1a.

On the other hand, if the another transport vehicle 1b cannot be specified, the first periphery information generator 146 sets the sensor information SI obtained by the sensor information obtainer 142 as it is, to the periphery information M2 of the own transport vehicle 1a, in Step S16.

The first periphery information generator 146 stores in the storage 141 the periphery information M2 generated as described above together with the time stamp of the generation thereof.

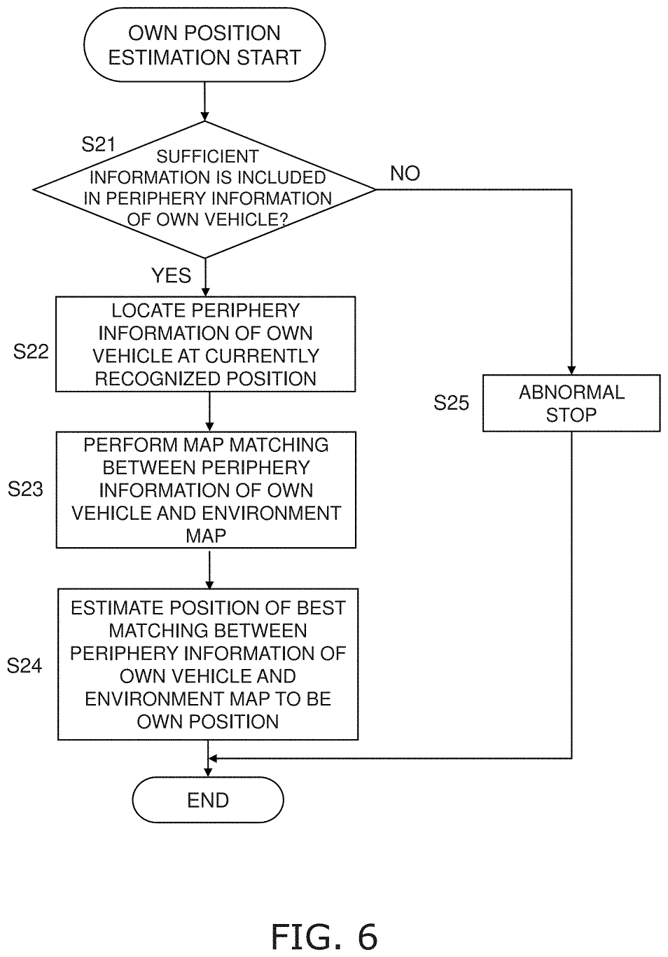

Hereinafter, with reference to FIG. 6, the own position estimation operation performed in Step S3 in FIG. 4 is described. FIG. 6 is a flowchart illustrating the own position estimation operation.

In Step S21, the own position estimator 143 determines whether or not the periphery information M2 generated in Step S2 includes sufficient information. For instance, if the number of coordinates (the number of detected obstacles and the like) included in the periphery information M2 is a predetermined value or more, the own position estimator 143 determines that the periphery information M2 includes sufficient information.

If the periphery information M2 includes sufficient information (“Yes” in Step S21), the own position estimation operation proceeds to Step S22. In contrast, if the periphery information M2 does not include sufficient information (“No” in Step S21), the own position estimation operation proceeds to Step S25.

In Step S22, the own position estimator 143 locates the periphery information M2 at the position estimated by dead reckoning on the environment map M1. Specifically, the own position estimator 143 first calculates the present position and direction of the own transport vehicle 1a in the movement area ME based on the rotation amounts of the motors 121a and 121b obtained from the encoders 125a and 125b.

Next, the own position estimator 143 locates the periphery information M2 generated in Step S2 at the position on the environment map M1 corresponding to the position estimated by dead reckoning. Furthermore, the own position estimator 143 rotates the periphery information M2 at the position by the direction (angle) estimated by dead reckoning.

In Step S23, the own position estimator 143 performs map matching between the environment map M1 and the periphery information M2. Specifically, the own position estimator 143 moves in parallel and rotates the periphery information M2 within a predetermined range with respect to the present arrangement position of the periphery information M2 as the center, and calculates a degree of matching between the environment map M1 and the periphery information M2 after the parallel movement and rotation.

In Step S24, the own position estimator 143 estimates the own position and own direction of the own transport vehicle 1a to be the position and direction (angle) of the periphery information M2 when the degree of matching between the periphery information M2 and the environment map M1 is maximum, as a result of the map matching described above.

Specifically, the own position estimator 143 adds the position estimated by dead reckoning to the parallel movement amount of the periphery information M2 when the degree of matching is maximum, to calculate the own position. On the other hand, it adds the direction estimated by dead reckoning to the rotation amount of the periphery information M2 when the degree of matching is maximum, so as to calculate the own direction. The own position estimator 143 stores in the storage 141 the calculated own position and own direction as the position information PI of the own transport vehicle 1a.

If the periphery information M2 of the own transport vehicle 1a includes sufficient information, the own position estimator 143 can estimate the own position and own direction as described above.

In contrast, if the periphery information M2 of the own transport vehicle 1a does not include sufficient information, it is determined that the own position estimator 143 cannot perform the own position estimation, and an abnormal stop of the own transport vehicle 1a occurs in Step S25.

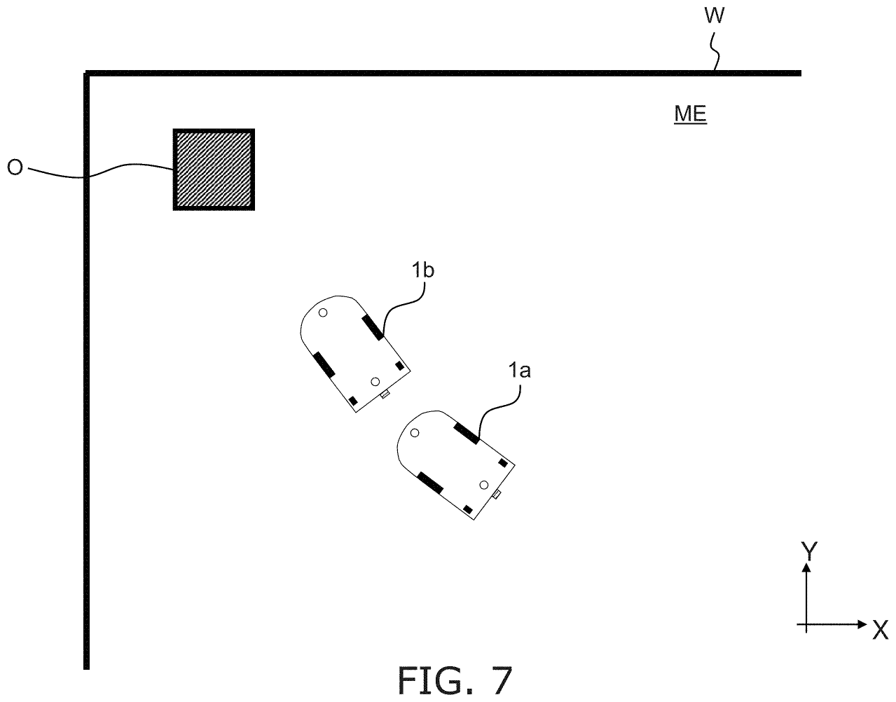

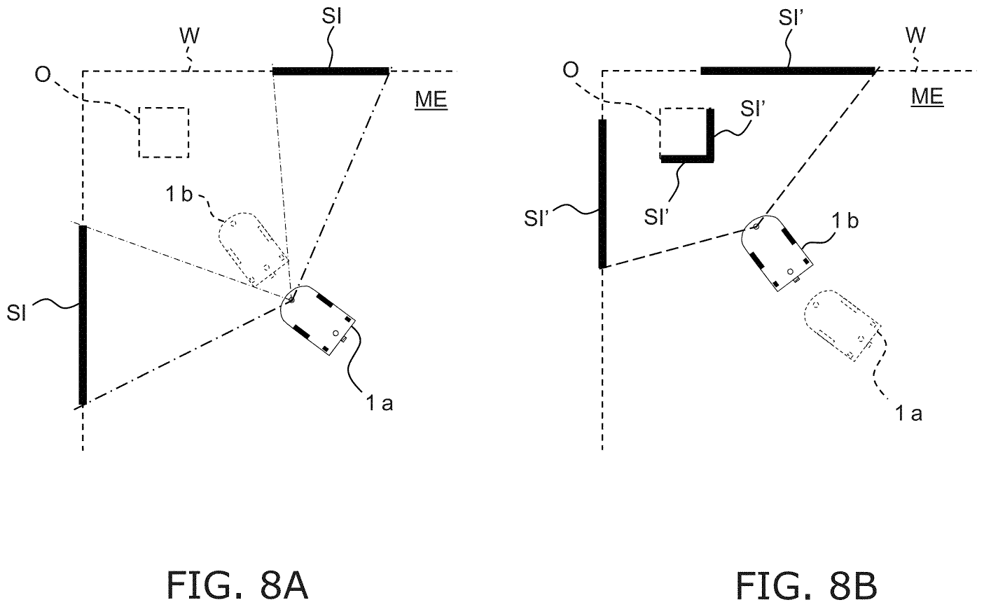

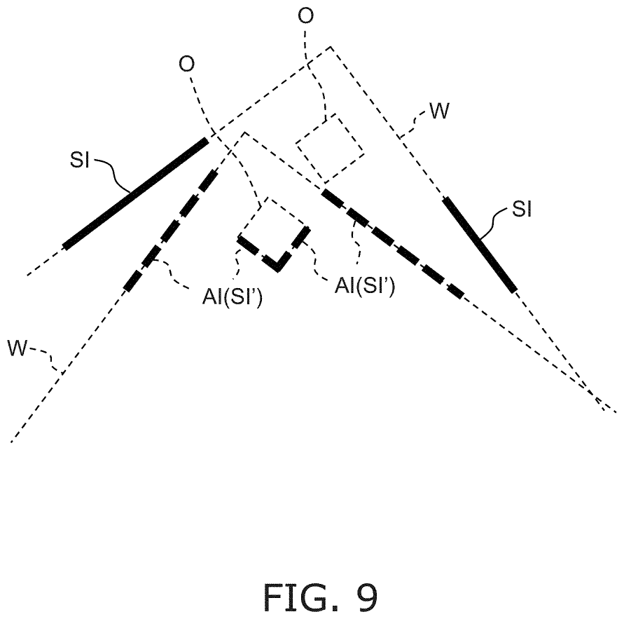

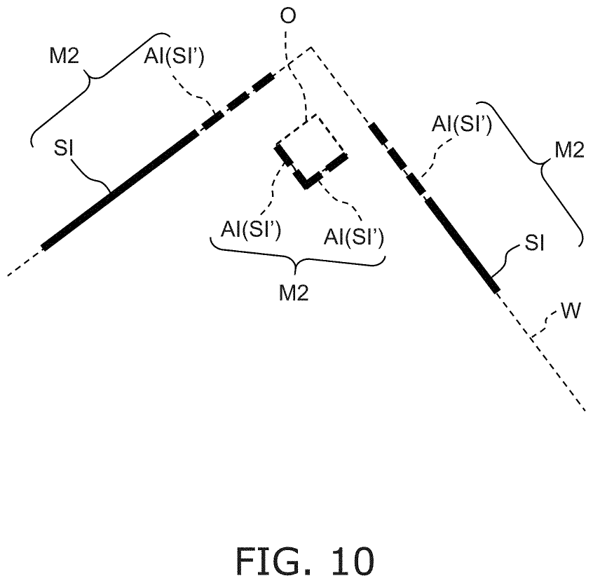

With reference to FIGS. 7 to 10, there is described an advantage of adding the periphery information M2′ of the another transport vehicle 1b to the sensor information SI of the own transport vehicle 1a. FIG. 7 is a diagram illustrating an example of a case where another transport vehicle 1b exists in front of the own transport vehicle 1a. FIG. 8A is a diagram illustrating an example of the sensor information SI obtained by the own transport vehicle 1a. FIG. 8B is a diagram illustrating an example of the periphery information M2′ obtained by the another transport vehicle 1b. FIG. 9 is a diagram illustrating an example of a case where the periphery information M2′ of the another transport vehicle 1b is added as it is. FIG. 10 is a diagram illustrating an example of a case where the periphery information M2′ of the another transport vehicle 1b is offset and then is added.

In FIG. 7, another transport vehicle 1b exists in front of the own transport vehicle 1a. In addition, the material placement portion O exists in front of the another transport vehicle 1b.

In the case illustrated in FIG. 7, a field of view of the sensor information obtainer 142 of the own transport vehicle 1a is partially blocked by the another transport vehicle 1b. Therefore, the sensor information obtainer 142 of the own transport vehicle 1a obtains the sensor information SI that does not include information of the material placement portion O as illustrated in FIG. 8A.

In contrast, a field of view of the sensor information obtainer 142 of the another transport vehicle 1b is not blocked by existence of another transport vehicle 1. Therefore, the sensor information obtainer 142 of the another transport vehicle 1b obtains the periphery information M2′ (sensor information SI′) that includes information of the material placement portion O as illustrated in FIG. 8B.

When the own transport vehicle 1a and the another transport vehicle 1b are in the positional relationship as illustrated in FIG. 7, and if the periphery information M2′ of the another transport vehicle 1b is not added to the sensor information SI of the own transport vehicle 1a, the information volume of the sensor information SI of the own transport vehicle 1a is small. Therefore, in the own transport vehicle 1a, the accuracy of the map matching between the periphery information M2 and the environment map M1 is deteriorated, or the map matching cannot be performed.

On the other hand, in this preferred embodiment, in order to add more information to the sensor information SI of the own transport vehicle 1a, the sensor information SI′ included in the periphery information M2′ of the another transport vehicle 1b is added as the supplementary information AI to the sensor information SI of the own transport vehicle 1a, and the periphery information M2 of the own transport vehicle 1a is generated.

However, if the sensor information SI′ included in the periphery information M2′ of the another transport vehicle 1b is simply added to the sensor information SI of the own transport vehicle 1a, the periphery information M2 cannot accurately represent a state around the own transport vehicle 1a, as illustrated in FIG. 9. This periphery information M2 is not appropriate because the sensor information SI and the periphery information M2′ are generated with respect to the center of the transport vehicle 1 as the origin, and indicate information of the wall W, the material placement portion O, and the like viewed in the forward direction of the transport vehicle 1.

In other words, if the sensor information SI′ included in the periphery information M2′ is added to the sensor information SI without considering the positional relationship between the own transport vehicle 1a and the another transport vehicle 1b, appropriate periphery information M2 cannot be generated.

Therefore, the first periphery information generator 146 of this preferred embodiment generates the periphery information M2, by adding the sensor information SI′ included in the periphery information M2′ of the another transport vehicle 1b to the sensor information SI of the own transport vehicle 1a, with considering the positional relationship between the own transport vehicle 1a and the another transport vehicle 1b.

Specifically, the first periphery information generator 146 moves in parallel the periphery information M2′ by a difference between the position of the own transport vehicle 1a estimated by dead reckoning and the position indicated in the position information PI′ of the another transport vehicle 1b, to move the origin position of the periphery information M2′ to the position corresponding to a relative position of the another transport vehicle 1b viewed from the own transport vehicle 1a. In addition, it rotates the periphery information M2′ by a difference between the direction of the own transport vehicle 1a estimated by dead reckoning and the direction indicated in the position information PI′ of the another transport vehicle 1b to change the direction of the periphery information M2′ by the angle corresponding to a relative direction of the another transport vehicle 1b viewed from the own transport vehicle 1a. After this, the first periphery information generator 146 adds the sensor information SI′ included in the periphery information M2′ after the parallel movement and rotation as the supplementary information AI to the sensor information SI of the own transport vehicle 1a, and generate the periphery information M2 of the own transport vehicle 1a.

As described above, the sensor information SI′ included in the periphery information M2′ after the parallel movement and rotation is added to the sensor information SI of the own transport vehicle 1a to generate the periphery information M2. Thus, as illustrated in FIG. 10, information that is not included in the field of view of the sensor information obtainer 142 of the own transport vehicle 1a can be included in the periphery information M2 of the own transport vehicle 1a. In the example illustrated in FIG. 10, the information of the wall W and the material placement portion O, which is not included in the sensor information SI of the own transport vehicle 1a, is included in the periphery information M2 of the own transport vehicle 1a (the map information that is used to estimate the own position).

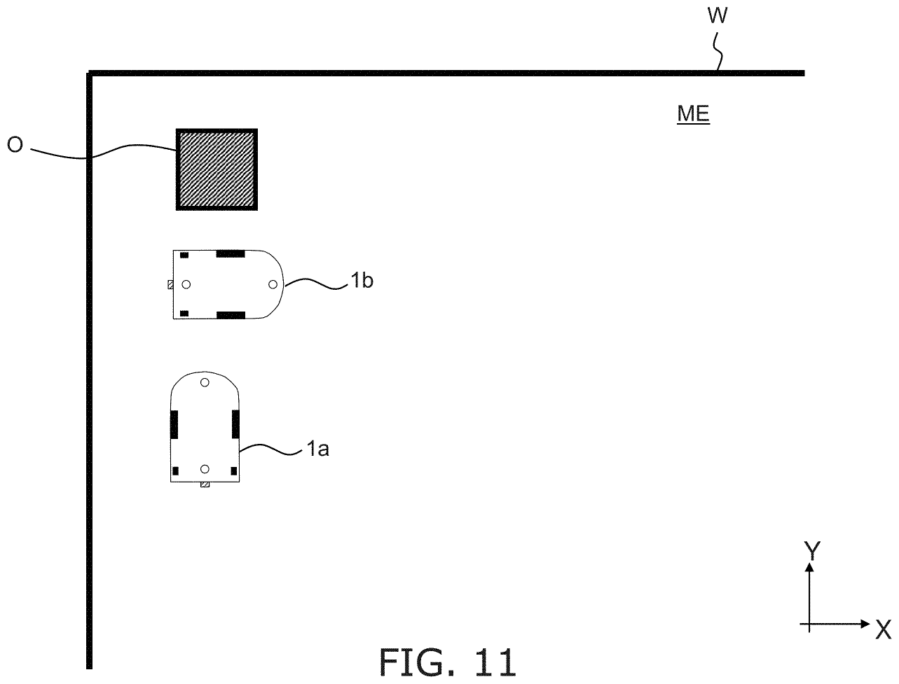

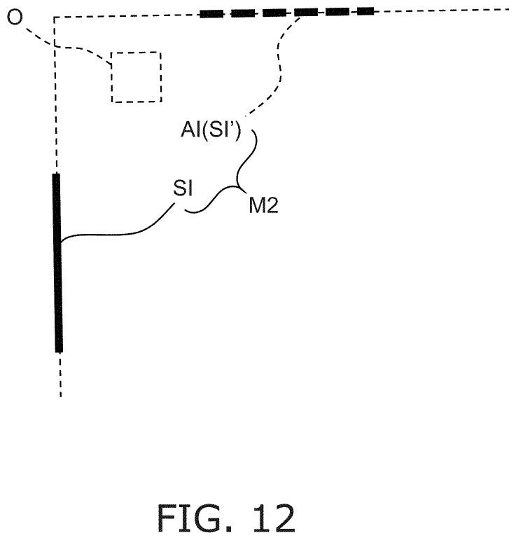

With reference to FIGS. 11 and 12, there is described Example 2 of adding the sensor information SI′ included in the periphery information M2′ of the another transport vehicle 1b to the sensor information SI of the own transport vehicle 1a. FIG. 11 is a diagram illustrating another example of a case where another transport vehicle 1b exists in front of the own transport vehicle 1a. FIG. 12 is a diagram illustrating another example of a case where the sensor information SI′ included in the periphery information M2′ of another transport vehicle 1b is offset and then is added.

In FIG. 11, another transport vehicle 1b exists in front of the own transport vehicle 1a. However, the own transport vehicle 1a is directed in the Y direction, while the another transport vehicle 1b is directed in the X direction.

In the case illustrated in FIG. 11, the field of view of the sensor information obtainer 142 of the own transport vehicle 1a is partly blocked by the another transport vehicle 1b. In contrast, the field of view of the sensor information obtainer 142 of the another transport vehicle 1b is not blocked by existence of another transport vehicle 1.

In the case illustrated in FIG. 11, in the same manner as described above in Example 1, the sensor information SI′ included in the periphery information M2′ of another transport vehicle 1b is added as the supplementary information AI to the sensor information SI of the own transport vehicle 1a, and the periphery information M2 as illustrated in FIG. 12 is generated in the own transport vehicle 1a.

As illustrated in FIG. 12, the sensor information SI of the own transport vehicle 1a includes only information of one surface of the wall W (surface extending in the Y direction). In this case, position estimation by map matching is difficult. On the other hand, when the sensor information SI′ included in the periphery information M2′ of another transport vehicle 1b is added as the supplementary information AI to the sensor information SI of the own transport vehicle 1a, the periphery information M2 of the own transport vehicle 1a includes not only the information of one surface of the wall W extending in the Y direction but also information of another surface extending in the X direction perpendicular thereto. In this way, if the periphery information M2 includes information of two or more surfaces extending in different directions, the own position estimation can be performed by map matching between the periphery information M2 and the environment map M1.

It should be noted that the above description can also be applied in the same manner to a case where three or more transport vehicles 1 are lined up in the movement area ME. For instance, in the case of FIG. 7, if another transport vehicle 1c exists and travels behind the own transport vehicle 1a in substantially the same direction as the own transport vehicle 1a, the transport vehicle 1c moves in parallel and rotates the sensor information SI included in the periphery information M2 generated by the transport vehicle 1a to add the same to the sensor information SI obtained by the transport vehicle 1c, and thus it can generate the periphery information that is used to estimate the own position of the transport vehicle 1c. In other words, the periphery information of the transport vehicle 1c includes the sensor information obtained by the transport vehicle 1c and the added sensor information SI and SI′ of the transport vehicles 1a and 1b.

In this case, even if the transport vehicle 1c cannot specify the another transport vehicle 1b, the another transport vehicle 1c can add the sensor information SI obtained by the another transport vehicle 1b to the periphery information of the transport vehicle 1c. In the transport vehicle 1a, the periphery information M2, to which the sensor information SI′ included in the periphery information M2′ of another transport vehicle 1b is added, is generated, and the sensor information SI of the transport vehicle 1c is added to the sensor information SI included in the periphery information M2 so that the periphery information of the transport vehicle 1c is generated.

It should be noted that in another preferred embodiment, when generating the periphery information of the transport vehicle 1c, only the sensor information SI stored in the transport vehicle 1a may be obtained, and added to the sensor information of the transport vehicle 1c, to generate the periphery information of the transport vehicle 1c.

The transport vehicle system 100 according to the first preferred embodiment described above has the following effects. It should be noted that all the following effects may be obtained, but one or a portion of them may be obtained.

Firstly, as the sensor information SI′ included in the periphery information M2′ stored in the another transport vehicle is added as the supplementary information AI to the sensor information SI obtained by the own transport vehicle, to generate the periphery information M2 of the own transport vehicle 1a, the own position estimator 143 of the own transport vehicle 1a can accurately estimate the own position and own direction of the own transport vehicle 1a, by map matching between the environment map M1 and the periphery information M2 including more information than the sensor information SI obtained by the own transport vehicle 1a. This is because, in the position estimation by map matching in general, the larger the number of points (information) to be matched exists, the higher the accuracy of the position estimation becomes.

Secondly, if there is much information included in the periphery information M2, the possibility of an abnormal stop of the own transport vehicle 1a can be reduced. The abnormal stop occurs when it is determined that sufficient information is not included in the periphery information M2 of the own transport vehicle 1a in Step S21 described above, for example. As described above, the own transport vehicle 1a can continue traveling to a target position without decelerating or stopping during the travel.

Thirdly, in this preferred embodiment, regardless whether or not the periphery information M2′ of another transport vehicle 1b is obtained, the periphery information M2 of the own transport vehicle 1a is generated, and the own position estimation is performed by map matching between the periphery information M2 and the environment map M1. In other words, in this preferred embodiment, the same method of estimating own position is used regardless whether or not the periphery information M2′ of another transport vehicle 1b is used to generate the periphery information M2. As a result, the control to change the method of estimating own position is not necessary depending on whether or not the periphery information M2′ is obtained.

Fourthly, as the periphery information M2′ stored in the another transport vehicle 1b is added to the sensor information SI of the own transport vehicle 1a, even if an unexpected obstacle such as another transport vehicle 1b exists around the own transport vehicle 1a, the own transport vehicle 1a can reduce an influence of existence of the obstacle to accurately estimate the own position. Even if the sufficient sensor information SI cannot be obtained because of existence of the unexpected obstacle, the own transport vehicle 1a can generate the periphery information M2 including more information by adding the sensor information SI′ included in the periphery information M2′ to the sensor information SI of the own transport vehicle.

Fifthly, if the periphery information M2′ stored in the another transport vehicle 1b is obtained via the communicator 145 of the own transport vehicle 1a, the first periphery information generator 146 adds the sensor information SI′ included in periphery information M2′ to the sensor information SI of the own transport vehicle 1a. In other words, if the periphery information M2′ is not obtained, the first periphery information generator 146 sets the sensor information SI obtained by the own transport vehicle to the periphery information M2.

In this way, the own transport vehicle 1a can perform the position estimation by comparing the environment map M1 with the periphery information M2 of the own transport vehicle, regardless whether or not the periphery information M2′ stored in the another transport vehicle 1b is obtained. In other words, the own transport vehicle 1a can use the same method of estimating own position regardless whether or not the periphery information M2′ is obtained.

### Second Preferred Embodiment

In the first preferred embodiment, the own transport vehicle 1a obtains the position information PI′ of the another transport vehicle 1b from the another transport vehicle 1b via the communicator 145. However, the method of obtaining the position information of another transport vehicle is not limited. For instance, the information about position (position information) of the another transport vehicle 1b, and whether or not the another transport vehicle 1b exists, can be determined based on the sensor information SI obtained by the laser range sensor 13.

In the transport vehicle system according to the second preferred embodiment, if the sensor information SI includes information about a shape that is unique to the another transport vehicle 1b, the first periphery information generator 146 can calculate the parallel movement amount and rotation amount of the periphery information M2′, based on a distance between the origin position of the sensor information SI and information indicating the shape of the another transport vehicle 1b (coordinate values of a group of points), and a direction where the information exists viewed from the origin position.

Other than that, for example, it may be possible to store in the storage 141 a model indicating a shape of a plurality of transport vehicles 1, and to perform “map matching” between the model and the sensor information SI, and thus it is possible to calculate the relative position and direction of the another transport vehicle 1b with respect to the own transport vehicle 1a, i.e., the parallel movement amount and rotation amount of the periphery information M2′. When performing the “map matching” described above, it is possible to specify a machine number or the like of the transport vehicle 1 based on the degree of matching between the model of the transport vehicle 1 and the information corresponding to the transport vehicle 1 in the sensor information SI.

As described above, when recognizing the existence and the position information of the another transport vehicle 1b based on the information obtained by the laser range sensor 13, it is not necessary to obtain the position information PI′ from the another transport vehicle 1b. In addition, for example, if it is recognized from the image obtained by the camera 147 that another transport vehicle 1b exists in front thereof, but if the position information PI′ cannot be obtained from the another transport vehicle 1b, the first periphery information generator 146 can estimate the position information of the another transport vehicle 1b from the sensor information SI.

It should be noted that the transport vehicle system according to the second preferred embodiment preferably is different from that according to the first preferred embodiment only in the method of determining the position information of the another transport vehicle, and other structures and functions are the same as those of the first preferred embodiment. Therefore, the description of other structures, functions, and the like of the transport vehicle system according to the second preferred embodiment is omitted.

### Third Preferred Embodiment

In the first preferred embodiment and the second preferred embodiment, the specifier 148 specifies the another transport vehicle 1b by image processing of the image obtained by the camera 147. However, the method of specifying the another transport vehicle is not limited.

In the transport vehicle system according to a third preferred embodiment, the specifier 148 specifies the another transport vehicle 1b based on information (an example of specifying information) of the another transport vehicle 1b input from the host controller 3. The information to specify the another transport vehicle 1b can be, for example, the transport command allocated to the another transport vehicle 1b by the host controller 3. In other words, the specifying information in this preferred embodiment includes information about conditions to specify a transport vehicle (conditions about travel indicated in the transport command).

In this case, the specifier 148 can specify the another transport vehicle 1b based on, for example, the travel start position and end position indicated in the transport command, and the elapsed time after the transport command is output. Specifically, the specifier 148 specifies another transport vehicle 1b existing near the transport route of the own transport vehicle 1a based on, for example, the transport command and the position information PI and PI′ of the own transport vehicle 1a and the another transport vehicle 1b, and the own transport vehicle 1a and the specified another transport vehicle 1b can directly communicate with each other.

In the transport vehicle system according to third preferred embodiment, in which information of the another transport vehicle 1b is obtained from the host controller 3, the camera 147 may be eliminated. Alternatively, the specifier 148 may specify the another transport vehicle 1b based on information obtained from the host controller 3, if the another transport vehicle 1b cannot be specified because the camera 147 cannot obtain the image or for other reason.

It should be noted that the transport vehicle system according to the third preferred embodiment preferably is different from that according to the first or second preferred embodiment only in the method of specifying the another transport vehicle, and other structures and functions are the same as those according to the first or second preferred embodiment. Therefore, description of other structures, functions, and the like of the transport vehicle system according to the third preferred embodiment is omitted.

### Fourth Preferred Embodiment

In the first preferred embodiment and the second preferred embodiment, the specifier 148 specifies the another transport vehicle 1b by image processing of the image obtained by the camera 147, and in the third preferred embodiment it specifies the another transport vehicle 1b based on information input from the host controller 3. Without limiting to this, still another method may be used to specify the another transport vehicle 1b.

In the transport vehicle system according to the fourth preferred embodiment, the specifier 148 can specify the another transport vehicle 1b based on information (an example of specifying information) about the transport vehicle 1 in a range communicable via the communicator 145. In other words, the specifying information in this preferred embodiment is information about conditions to specify the transport vehicle (information about the transport vehicle in the communicable range). In this way, a communication load of the communicator 145 can be reduced by obtaining the periphery information M2′ from another transport vehicle 1b in the limited range.

In the transport vehicle system according to the fourth preferred embodiment, information about the transport vehicle 1 can be, for example, signal reception intensity from the communicator 145 of the another transport vehicle 1. In addition, this signal includes, for example, information to specify the transport vehicle 1, such as an identification number (machine number) of the transport vehicle 1, an address (such as a MAC address or an IP address) of the communicator 145 of the transport vehicle 1, identification information (such as SSID) of the communicator 145, or the like.

When specifying the another transport vehicle 1b based on the reception intensity, the specifier 148 can specify the another transport vehicle 1b based on the above-mentioned identification information included in the signal if it receives the signal at intensity of a predetermined threshold value or more.

In the transport vehicle system according to the fourth preferred embodiment, in which the transport vehicle 1 in a range communicable via the communicator 145 is specified to be the another transport vehicle 1b, the camera 147 may be eliminated. Alternatively, the specifier 148 may specify the another transport vehicle 1b based on information about the transport vehicle 1 in a range communicable via the communicator 145 (an example of specifying information), if the another transport vehicle 1b cannot be specified because the camera 147 cannot obtain the image or for other reason.

In addition, in the transport vehicle system according to the fourth preferred embodiment, information to specify the another transport vehicle 1b may not be received from the host controller 3. Alternatively, the specifier 148 may specify the another transport vehicle 1b based on information about the transport vehicle 1 in a range communicable via the communicator 145 (an example of specifying information), if the another transport vehicle 1b cannot be specified because information is not obtained from the host controller 3.

It should be noted that the transport vehicle system according to the fourth preferred embodiment preferably is different from that according to the first preferred embodiment to the third preferred embodiment only in the method of specifying the another transport vehicle, and other structures and functions are the same as those according to the first preferred embodiment to the third preferred embodiment. Therefore, description of other structures, functions, and the like of the transport vehicle system according to the fourth preferred embodiment is omitted.

### Fifth Preferred Embodiment

In the first preferred embodiment to the fourth preferred embodiment, the transport vehicle 1 that can be specified by the specifying method is specified as the another transport vehicle 1b, and the periphery information M2′ is received from the specified another transport vehicle 1b.

Without limiting to this, for example, in the transport vehicle system according to the fifth preferred embodiment, including a small number of the (operating) transport vehicles 1, the periphery information M2′ may be obtained from every transport vehicle 1 without specifying the another transport vehicle 1b from which the periphery information M2′ should be received.

In this way, as the periphery information M2′ is obtained from all of other transport vehicles 1b, the sensor information SI′ included in the more periphery information M2′ are added to the sensor information SI of the own transport vehicle 1a, and the periphery information M2 containing more information can be used to perform more accurate position estimation.

It should be noted that when obtaining the periphery information M2′ from all of other transport vehicles 1b, the first periphery information generator 146 obtains the position information PI′ from all of other transport vehicles 1b in the same manner as the first preferred embodiment, or estimates position of all of other transport vehicles 1b based on the sensor information SI obtained by the laser range sensor 13.

In addition, in order to specify which another transport vehicle 1b exists at which position, the specifier 148 specifies each transport vehicle 1 from the image obtained by the camera 147, or specifies each transport vehicle 1 based on the transport command or the like output from the host controller 3.

It should be noted that the transport vehicle system according to the fifth preferred embodiment preferably is different from that according to the first preferred embodiment to the fourth preferred embodiment only in that the periphery information M2′ is obtained from every transport vehicle 1 without specifying the another transport vehicle 1b, and other structures and functions are the same as those according to the first preferred embodiment to the fourth preferred embodiment. Therefore, description of other structures, functions, and the like of the transport vehicle system according to the fifth preferred embodiment is omitted.

The first preferred embodiment to the fifth preferred embodiment preferably include the following common structures and functions, for example.

The transport vehicle system (e.g., the transport vehicle system 100) includes a plurality of transport vehicles (e.g., the transport vehicles 1a to 1e), and a map data storage (e.g., the storage 141). Each of the plurality of transport vehicles includes a distance measurement sensor (e.g., the laser range sensor 13), an onboard controller (e.g., the onboard controller 14), and a communicator (e.g., the communicator 145). The map data storage stores map data (e.g., the environment map M1) storing a peripheral object (e.g., the wall W and the material placement portion O) in a movement area (e.g., the movement area ME).

The onboard controller of the transport vehicle described above includes an estimator (e.g., the own position estimator 143) and a first periphery information generator (e.g., the first periphery information generator 146). The estimator is configured or programmed to estimate the own position of the own transport vehicle, based on first periphery information (e.g., the periphery information M2 of the own transport vehicle 1a), currently recognized position information of the own transport vehicle (e.g., the own transport vehicle 1a), and the map data. The first periphery information is periphery information of the own transport vehicle including first sensor information (e.g., the sensor information SI) obtained by the distance measurement sensor of the own transport vehicle.

When supplementary information (e.g., the supplementary information AI, i.e., the sensor information SI′ included in the periphery information M2′ of another transport vehicle 1b) is obtained via the communicator of the own transport vehicle, the first periphery information generator adds the supplementary information to the first sensor information to generate the first periphery information. The supplementary information includes second sensor information obtained by the distance measurement sensor of the another transport vehicle.

In the transport vehicle system described above, if the own transport vehicle obtains the supplementary information from another transport vehicle via the communicator, the first periphery information generator of the own transport vehicle adds the supplementary information to the first sensor information obtained by the distance measurement sensor of the own transport vehicle, to generate the first periphery information that is used to estimate an own position of the own transport vehicle.

In this way, the first periphery information is generated by adding the supplementary information stored in another transport vehicle to the sensor information obtained by the own transport vehicle, and the own transport vehicle can use the first periphery information including more information than the first sensor information obtained by the own transport vehicle, so as to estimate the own position more accurately.

In addition, as the supplementary information stored in another transport vehicle is added to the first sensor information of the own transport vehicle, even if an unexpected obstacle including another transport vehicle exists in a periphery thereof, the own transport vehicle can reduce an influence of existence of the obstacle, so that the own position estimation can be accurately performed. Even if the sufficient first sensor information cannot be obtained because of existence of the unexpected obstacle, the own transport vehicle can generate the first periphery information including more information by adding the supplementary information to the first sensor information of the own transport vehicle.

Furthermore, when the supplementary information stored in another transport vehicle is obtained via the communicator of the own transport vehicle, the first periphery information generator adds the supplementary information to the first sensor information. In other words, if the supplementary information is not obtained, the first periphery information generator sets the first sensor information obtained by the own transport vehicle to the first periphery information.

In this way, regardless whether or not the supplementary information stored in another transport vehicle is obtained, the own transport vehicle can perform position estimation by comparing the first periphery information with the map data. In other words, the own transport vehicle can use the same method of estimating own position regardless whether or not the supplementary information is obtained.

### Other Preferred Embodiments

Although various preferred embodiments of the present invention are described above, the present invention is not limited to the preferred embodiments described above, but can be variously modified within the scope of the invention without deviating from the spirit thereof. In particular, the preferred embodiments and variations described in this specification can be arbitrarily combined as necessary.

When combining the first preferred embodiment to the fifth preferred embodiment, it may be possible to determine which preferred embodiment of the control operation is performed in accordance with setting of operation mode. In addition, it may be possible to determine in advance which operation should be prioritized among the determining operations of the relative position of the another transport vehicle 1b with respect to the own transport vehicle 1a, and among the specifying operations of the another transport vehicle 1b.

In the first preferred embodiment to the fifth preferred embodiment, there is mainly described the case where another transport vehicle 1b exists in front of the own transport vehicle 1a, but the position of the another transport vehicle 1b with respect to the own transport vehicle 1a is not limited. For instance, the supplementary information AI to be added to the sensor information SI may be obtained also from another transport vehicle 1b existing behind the own transport vehicle 1a.

In this way, for example, if the periphery information M2′ having a complicated shape is obtained by another transport vehicle 1b existing behind the own transport vehicle 1a, the sensor information SI′ included in the periphery information M2′ is added as the supplementary information AI to the sensor information SI, and the periphery information M2 having the complicated shape can be generated. In the position estimation by map matching, an accuracy of the position estimation accuracy is improved in general as the shape of the map used to match is more complicated. Therefore, by making the shape of the periphery information M2 complicated, position estimation can be performed more accurately.

When calculating the sensor information SI from the signal obtained by the laser range sensor 13, the sensor information obtainer 142 may generate the sensor information SI, by converting the relative distance of the object viewed from the main body 11, which is calculated from the time difference described above, and the angle of the light receiving surface when receiving the reflection light, into coordinate values on the coordinate plane indicating the movement area ME.

Specifically, for example, if the coordinate system indicating the movement area ME is the X-Y coordinate system, with respect to the position estimated when the sensor information SI is obtained (e.g., the position estimated by dead reckoning) as a reference, or with respect to the center of the main body 11 as the origin of the X-Y coordinate system, based on the relative distance (e.g., r) of the object viewed from the main body 11 and the angle (e.g., θ) of the light receiving surface when receiving the reflection light, the X coordinate value in the X-Y coordinate system is calculated to be r*cos θ, while the Y coordinate value is calculated to be r*sin θ, for example.

The transport vehicle system 100 described above can be applied not only to the system including transport vehicles but also to a system in which a plurality of robots cooperate to work, for example.

Preferred embodiments of the present invention and modifications and combinations thereof can be widely applied to transport vehicle systems.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1-13. (canceled)

14. A transport vehicle system comprising:
a plurality of transport vehicles, each including a distance measurement sensor, an onboard controller, and a communicator and configured or programmed to travel in a movement area; and
a map data storage to store map data storing a peripheral object existing in the movement area; wherein
the onboard controller is configured or programmed to include:
a first periphery information generator to add second sensor information obtained by the distance measurement sensor of another transport vehicle to first sensor information obtained by the distance measurement sensor of the own transport vehicle to generate first periphery information that is used to estimate a position of the own transport vehicle; and
an estimator to estimate a position of the own transport vehicle based on a result of map matching between the first periphery information that is generated by adding the second sensor information to the first sensor information and the map data.

15. The transport vehicle system according to claim 14, wherein the first periphery information generator is configured or programmed to add the second sensor information to the first sensor information, based on the position information of the own transport vehicle and position information of the another transport vehicle.

16. The transport vehicle system according to claim 15, wherein the first periphery information generator is configured or programmed to offset the second sensor information by a difference between the position information of the own transport vehicle and the position information of the another transport vehicle, and add the second sensor information to the first sensor information.

17. The transport vehicle system according to claim 15, wherein
the plurality of transport vehicles directly communicate with each other; and
the position information of the another transport vehicle is obtained together with the second sensor information from the another transport vehicle via the communicator.

18. The transport vehicle system according to claim 15, wherein the position information of the another transport vehicle is recognized based on information obtained by the distance measurement sensor of the own transport vehicle.

19. The transport vehicle system according to claim 14, wherein the first periphery information generator is configured or programmed to obtain the second sensor information from the another transport vehicle specified based on specifying information specifying the transport vehicle.

20. The transport vehicle system according to claim 19, wherein
the transport vehicle further includes a camera configured or programmed to photograph a front of the own transport vehicle in a travel direction; and
the specifying information is appearance information of the another transport vehicle photographed by the camera.

21. The transport vehicle system according to claim 19, further comprising a host controller configured or programmed to allocate transport commands to the plurality of transport vehicles; wherein
the specifying information is information about another transport vehicle recognized by the host controller as existing close to a transport route of the own transport vehicle based on the transport command.

22. The transport vehicle system according to claim 19, wherein the specifying information is information about another transport vehicle in a range communicable via the communicator.

23. The transport vehicle system according to claim 14, wherein the first periphery information generator is configured or programmed to obtain the second sensor information from all of other transport vehicles.

24. The transport vehicle system according to claim 14, wherein, if the second sensor information cannot be obtained via the communicator of the own transport vehicle, the first periphery information generator is configured or programmed to set the first sensor information to the first periphery information.

25. A transport vehicle of a transport vehicle system including a plurality of transport vehicles traveling in a movement area, the transport vehicle comprising:
a distance measurement sensor;
a communicator;
a first periphery information generator configured or programmed to add second sensor information obtained by the distance measurement sensor of another transport vehicle to first sensor information obtained by the distance measurement sensor of the transport vehicle to generate first periphery information that is used to estimate a position of the transport vehicle; and
an estimator configured or programmed to estimate a position of the transport vehicle based on a result of map matching between the first periphery information that is generated by adding the second sensor information to the first sensor information and the map data.

26. A method of controlling an own transport vehicle in a transport vehicle system including a plurality of transport vehicles each of which includes a distance measurement sensor and a communicator and is configured or programmed to travel in a movement area, and a map data storage to store map data storing a peripheral object existing in the movement area, the method comprising:
obtaining first sensor information by the distance measurement sensor of the own transport vehicle;
obtaining second sensor information obtained by the distance measurement sensor of another transport vehicle;
generating first periphery information by adding the second sensor information to the first sensor information, the first periphery information being used to estimate a position of the own transport vehicle; and
estimating a position of the own transport vehicle based on a result of map matching between the first periphery information that is generated by adding the second sensor information to the first sensor information and the map data.
